(19) United States
(12) Patent Application Publication
(10) Pub. No.: US 2004/0222897 A1
(43) Pub. Date: Nov. 11, 2004

(54) Nurse call indicator lamp

(76) Inventors: Werner Schuhmann, Munchen (DE); Andreas Brenner, Hohenkirchen (DE)

Correspondence Address: IP LEGAL DEPARTMENT, TYCO FIRE & SECURITY SERVICES, ONE TOWN CENTER ROAD, BOCA RATON, FL, 33486, US

(21) Appl. No.: 10/804,837

(22) Filed: Mar. 19, 2004

Related U.S. Application Data
(60) Provisional application No. 60/456,971, filed on Mar. 24, 2003.

(51) Int. Cl. G08B 5/22; G08B 1/00

(52) U.S. Cl. 340/815.45; 340/286.07

(57) ABSTRACT

A nurse call indicator includes a housing capable of supporting plural, individually replaceable indicator lamps, as well as plural indicator lamps. Each indicator lamp is mountable in a single indicator space within the housing. Indicator lamps may be single or multi-color, for example, by using different colored LEDs which light depending on the applied polarity.

### RELATED APPLICATIONS

This application claims the benefit of U.S. Provisional Application No. 60/456,971, filed Mar. 24, 2003. The entire teachings of the above application are incorporated herein by reference.

### BACKGROUND OF THE INVENTION

In the health care industry, particularly with certain hospitals and nursing homes, monitoring and call devices provide patient information to hospital staff. Indicator lights, or dome lamps located outside a patient's room notify hospital staff that certain conditions exist and alert the hospital staff when there is an emergency. Such a dome lamp may also show the status of an existing call and nurse presence information for each patient room. For example, one color light dome lamp may indicate a “code blue” which refers to an immediate life-threatening condition. Another color dome light may indicate a “patient call,” meaning that a patient needs nurse care. The number of sections or colors on a dome lamp varies with different systems and may require 2, 3, 4, 5, 6 or more different colors for each dome lamp.

In typical applications, 24V bulbs provide different colors in a dome lamp. FIG. 1 illustrates a typical four-color dome lamp using conventional 24V bulbs 11 positioned in snap-in sockets 13 in a housing 10, shown with the dome lamp cover off. A bulb is required for each corresponding color. Therefore, multi-colored dome lamps result in increased overall light/housing size. Some dome lamps utilize color light emitting diodes (LED) as light sources. However, replacing these LEDs can be arduous, typically requiring the removal and replacement of a printed circuit board fastened to the housing.

### SUMMARY OF THE INVENTION

Clearly, drawbacks exist with each of the dome lamp solutions discussed above. A need exists for a dome lamp application that utilizes LEDs that can replace existing 24V bulbs to avoid additional costs, and to provide multi-colored light with the least number of light sources per dome lamp for indicating different status information while minimizing overall dome fixture size.

A nurse call indicator, according to an embodiment of the present invention, includes a housing capable of supporting plural, individually replaceable indicator lamps, and the plural indicator lamps. At least one such indicator lamp includes a printed circuit board that fits within a single indicator space in the housing, and one or more LEDs mounted on the printed circuit board. Several LEDs of a single color may be activated simultaneously to provide extra brightness.

In one embodiment, each indicator lamp within the housing displays a distinct color.

Each indicator lamp can include a current-limiting resistor to enable the lamp to operate at a standard voltage, such as 24 VDC, normally used for a non-LED bulb.

In another embodiment, an indicator lamp is capable of displaying at least two colors, a first polarity activating a first color, and a second polarity activating a second color, for example, by using different colored LEDs. Such a multi-color indicator lamp can be used to identify different room statuses depending on the activated color.

In at least one embodiment, the housing has been constructed to accepted standard bulbs, e.g., 24 VDC bulbs. The indicator lamps are constructed such that each one is able to replace a standard bulb within the housing.

In another aspect of the present invention, an individually replaceable nurse call indicator lamp for use in a nurse call indicator housing includes a printed circuit board mountable in a single indicator space within the housing, and one or more LEDs mounted on the printed circuit board.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 illustrates a conventional dome lamp with 24V bulbs.

FIG. 2 illustrates the dome lamp housing of FIG. 1 in which LED indicator lamps according to an embodiment of the present invention have replaced the 24V bulbs.

FIG. 3 illustrates a single color LED indicator lamp in accordance with the present invention.

FIG. 4 is a schematic representation of the single color LED of FIG. 3.

FIG. 5 illustrates a dual color LED indicator lamp in accordance with the present invention.

FIG. 6 is a schematic representation of the dual color LED apparatus of FIG. 5.

FIG. 7 is a perspective view of an LED indicator lamp of FIG. 2 as seen from above.

FIG. 8 is a perspective view of the LED indicator lamp of FIG. 7 as seen from below.

FIG. 9 is a mechanical cut-away side-view of the LED indicator lamp of FIG. 2.

FIG. 10 is illustrates the single color LED indicator lamp of FIG. 3, shown without a cover, installed in the conventional dome lamp housing.

### DETAILED DESCRIPTION OF THE PREFERRED EMBODIMENTS

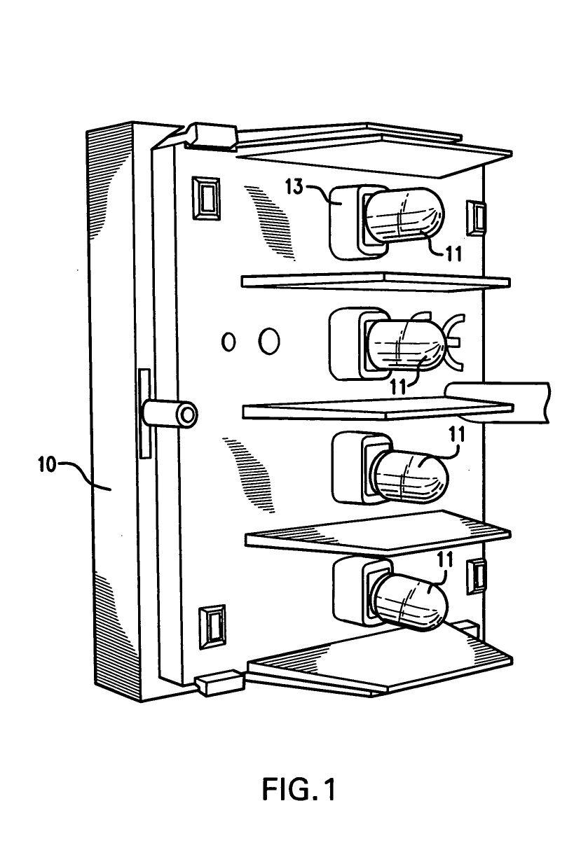

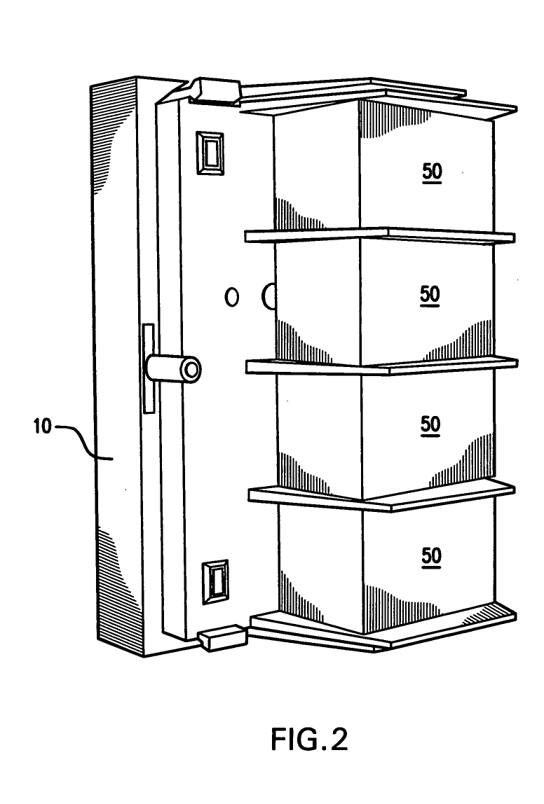

The apparatus in accordance with the present invention replaces existing 24V bulbs in dome light applications whereby LEDs fit into existing lamp housings. FIG. 2 illustrates a dome lamp housing 10 such as that shown in FIG. 1 in which LED indicator lamps 50 according to an embodiment of the present invention have replaced the 24V bulbs.

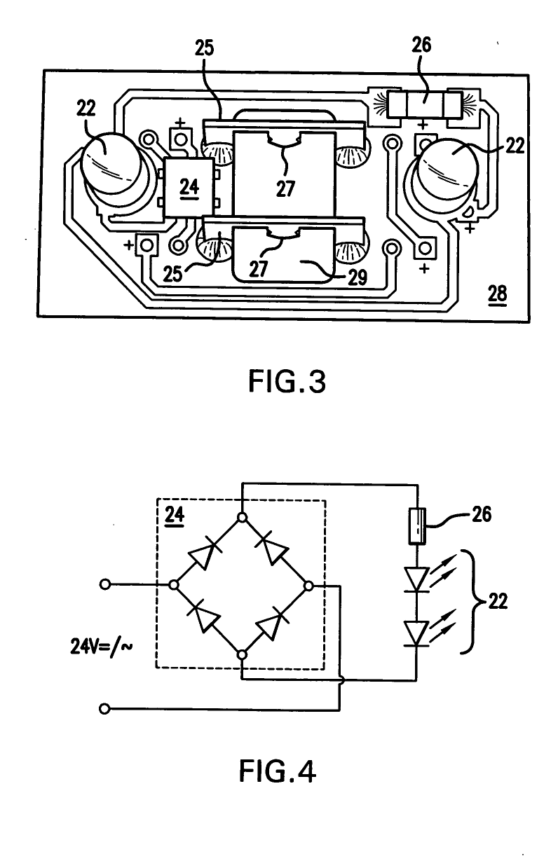

FIG. 3 illustrates a single color LED indicator lamp 20 in accordance with the present invention. This apparatus is used with a dome light housing (not shown). FIG. 4 is a schematic representation of the single color LED of FIG. 3.

Two LEDs 22 of the same color are mounted on a small printed circuit board 28. Two are used for increased brightness; however a single LED, or more than two LEDs could also be used. A bridge rectifier 24 ensures that regardless of how the printed circuit board 28 is installed in the housing 10 (FIG. 1), the correct polarity is delivered to the LEDs. Alternatively, mechanical means could be used to ensure that the board 28 may only be installed one way, obviated the need for the rectifier. A resistor 26 limits the current.

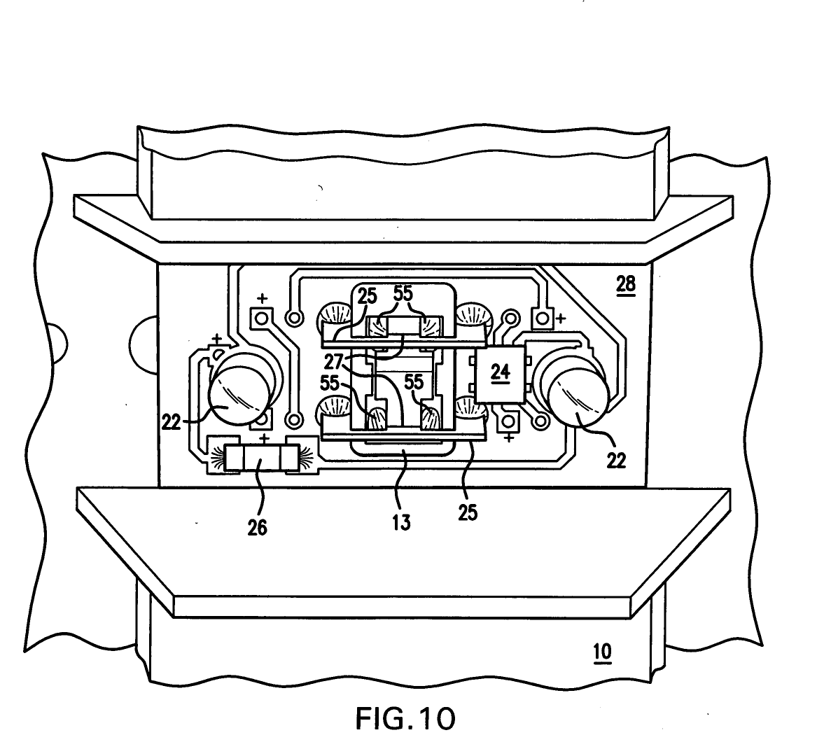

In one embodiment of the present invention, the LED indicator lamps are adapted to work with existing dome lamp housings. Thus, each printed circuit board 28 of this embodiment has a rectangular hole 29 designed to fit over a bulb mounting 16 (FIG. 1) which includes a snap-in socket. When so positioned, electrically conductive rails 25 make electrical contact with electrical contacts 55 (FIG. 10) within the bulb socket 13 (FIG. 1) and pick up the 24 VDC power from the socket. Protrusions 27 on the rails 25 provide two functions: first, when inserted into a socket, they mechanically hold the LED indicator lamp in place. Second, they provide the electrical connection to the socket.

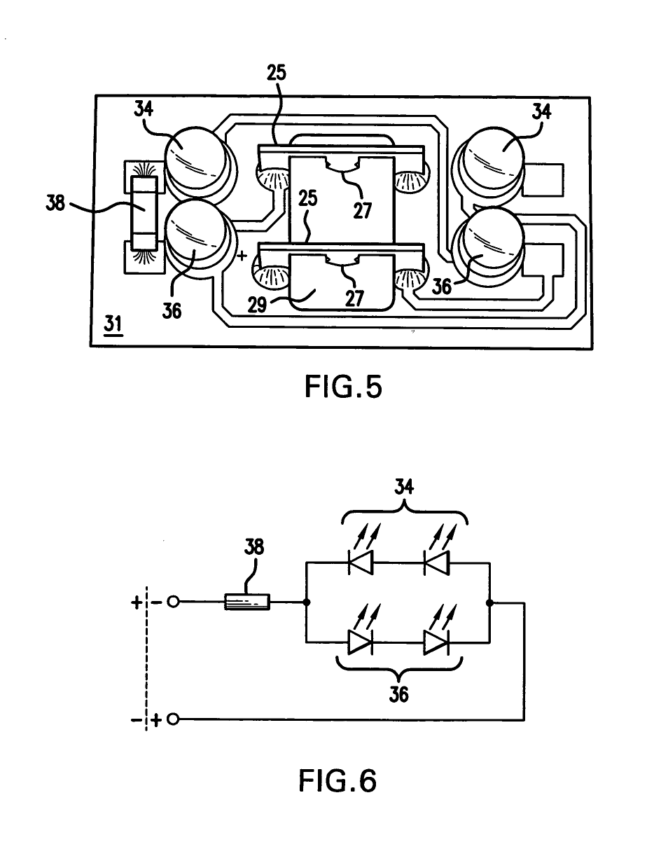

In another embodiment, two different colors are available within a single LED indicator lamp, which displays one of the two colors depending on the direction of current, i.e., the polarity of the 24 VDC power. FIG. 5 illustrates a populated printed circuit board 31 for a dual color LED indicator lamp in accordance with the present invention. Again, two LEDs are used for each color for brightness, but different numbers could be used. A first set or pair of LEDs 34, when activated, light in a first color, for example, white; a second set or pair of LEDs 36, when activated, light in a second color, for example, blue. A resistor 38 limits the current.

Such an indicator lamp can identify two different room statuses within a single section of the dome lamp. For example, the first section of a dome lamp may light white to signal a patient call, and blue to signal a “code blue.” FIG. 6 is a schematic representation of the dual color LED apparatus of FIG. 5. The polarity of the power on the two contact leads 25 controls which of the two colors is activated.

A third color can be achieved by alternating the polarity at a rate that is too fast for the human eye to detect. For example, if the first color were red and the second color green, alternating the polarity might produce an apparent color of orange, signifying yet a third room status within the single section of the dome lamp.

Alternatively, multi-color LEDs could be used in place of two discrete LEDs of different colors.

Additional color dome lamps can also be utilized for 4, 5 and 6 section applications by using dual color LED indicator lamps on one or more sections. By using LEDs instead of 24V bulbs, the current is approximately ten times smaller. In addition, by using LEDs, replacement issues associated with 24V bulbs is avoided.

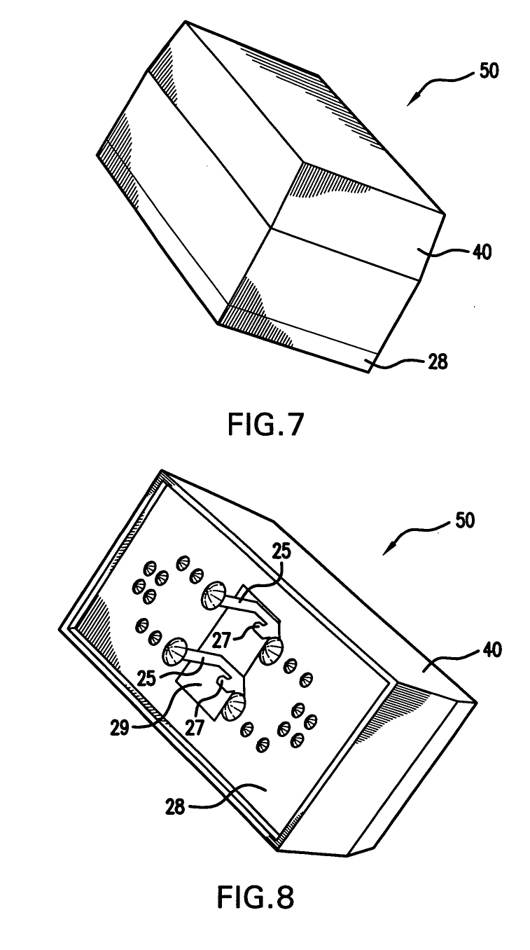

FIG. 7 is a perspective view of an LED indicator lamp of FIG. 2 as seen from above, showing a translucent cover 40 mounted over the printed circuit board 28. Such a cover helps to diffuse the light, as well as provide easy handling of the lamp for installation and removal.

FIG. 8 is a perspective view of the LED indicator lamp 50 of FIG. 7 as seen from below. The aperture 29, which fits over an existing bulb socket in the housing, is seen near the middle of the printed circuit board 28. Power rails 25 can be seen through the aperture 29.

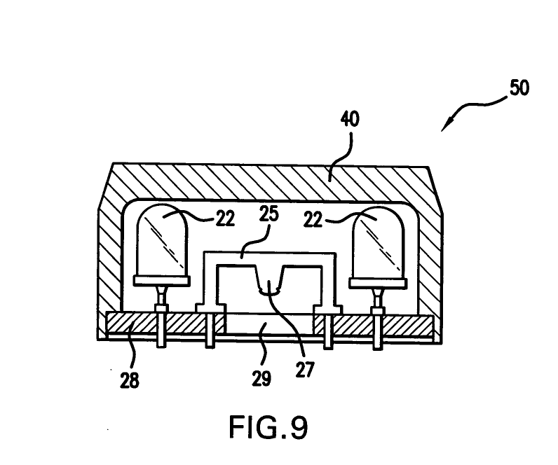

FIG. 9 is a mechanical cut-away side-view of the LED indicator lamp 50 of FIG. 2. Here, the protrusion 27 of rail 25 can be clearly seen. Upon installation of the lamp 50 in the housing 10, the protrusion 27 electrically contacts the snap-in socket to provide power.

FIG. 10 is illustrates the single color LED indicator lamp of FIG. 3, shown without a lens cover for illustrative purposes, installed in the conventional dome lamp housing 10. This illustration shows how the protrusions 27 of the conductive rails 25 come into contact with the electrical contacts 55 inside the incandescent bulb socket 13.

While this invention has been particularly shown and described with references to preferred embodiments thereof, it will be understood by those skilled in the art that various changes in form and details may be made therein without departing from the scope of the invention encompassed by the appended claims.

What is claimed is:

1. A nurse call indicator, comprising:
a housing capable of supporting plural, individually replaceable indicator lamps; and
said plural indicator lamps, each such indicator lamp comprising
a printed circuit board mountable in a single indicator space within the housing, and
at least one LED mounted on the printed circuit board.

2. The nurse call indicator of claim 1, each lamp displaying a distinct color.

3. The nurse call indicator of claim 1, each indicator lamp further comprising a resistor such that the lamp is able to operate at a standard voltage normally used for a non-LED bulb.

4. The nurse call indicator of claim 1, at least one of indicator lamp comprising plural LEDs of same color, the plural LEDs being activated simultaneously to provide extra brightness.

5. The nurse call indicator of claim 1, at least one indicator lamp being capable of displaying at least two colors, a first polarity activating a first color, and a second polarity activating a second color.

6. The nurse call indicator of claim 5, said multi-color indicator lamp having thereon different colored LEDs, the first polarity lighting a first LED having the first color, the second polarity lighting a second LED having the second color.

7. The nurse call indicator of claim 5, said multi-color indicator lamp identifying at least two different room statuses depending on the activated color.

8. The nurse call indicator of claim 1, the housing having been constructed to accept standard bulbs, each indicator lamp able to replace a standard bulb within the housing.

9. The nurse call indicator of claim 1, the printed circuit having mounted thereon means for electrically connecting the printed circuit to an incandescent bulb socket in the housing for the purpose of supplying power to said indicator lamp.

10. The nurse call indicator of claim 1, the printed circuit having mounted thereon electrically conductive rails for electrically connecting the printed circuit to an incandescent bulb socket in the housing for the purpose of supplying power to said indicator lamp, said rails having protrusions which, when inserted into said socket, are in electrical contact with said socket.

11. The nurse call indicator of claim 1, the printed circuit having an opening which fits over said socket.

12. An individually replaceable nurse call indicator lamp for use in a nurse call indicator housing capable of supporting plural indicator lamps, said indicator lamp comprising:
a printed circuit board mountable in a single indicator space within the housing, and
at least one LED mounted on the printed circuit board.

13. The nurse call indicator lamp of claim 12, each lamp installed in the housing displaying a distinct color.

14. The nurse call indicator lamp of claim 12, further comprising a resistor such that the lamp is able to operate at a standard voltage normally used for a non-LED bulb.

15. The nurse call indicator lamp of claim 12, further comprising plural LEDs of same color, the plural LEDs being activated simultaneously to provide extra brightness.

16. The nurse call indicator lamp of claim 12, said indicator lamp being capable of displaying at least two colors, a first polarity activating a first color, and a second polarity activating a second color.

17. The nurse call indicator lamp of claim 16, said indicator lamp having thereon different colored LEDs, the first polarity lighting a first LED having the first color, the second polarity lighting a second LED having the second color.

18. The nurse call indicator lamp of claim 16, said indicator lamp identifying at least two different room statuses depending on the activated color.

19. The nurse call indicator lamp of claim 12, the housing having been constructed to accept standard bulbs, said indicator lamp able to replace a standard bulb within the housing.

20. The nurse call indicator lamp of claim 12, the printed circuit having mounted thereon means for electrically connecting the printed circuit to an incandescent bulb socket in the housing for the purpose of supplying power to said indicator lamp.

21. The nurse call indicator lamp of claim 12, the printed circuit having mounted thereon electrically conductive rails for electrically connecting the printed circuit to an incandescent bulb socket in the housing for the purpose of supplying power to said indicator lamp, said rails having protrusions which, when inserted into said socket, are in electrical contact with said socket.

22. The nurse call indicator lamp of claim 12, the printed circuit having an opening which fits over said socket.

23. A method for replacing a nurse call dome lamp incandescent bulb with an LED indicator lamp, said method comprising:
removing the incandescent bulb; and
installing the LED indicator lamp in place of the incandescent bulb, the LED indicator lamp comprising
a printed circuit board mountable in a single indicator space within the housing, and
at least one LED mounted on the printed circuit board.

24. The method of claim 23, said indicator lamp being capable of displaying at least two colors, a first polarity activating a first color, and a second polarity activating a second color.

25. The method of claim 24, said indicator lamp having thereon different colored LEDs, the first polarity lighting a first LED having the first color, the second polarity lighting a second LED having the second color.

26. The method of claim 24, said indicator lamp identifying at least two different room statuses depending on the activated color.

27. The method of claim 23, the housing having been constructed to accept standard bulbs, said indicator lamp replacing a standard bulb within the housing.

28. The method of claim 23, the printed circuit having mounted thereon means for electrically connecting the printed circuit to an incandescent bulb socket in the housing for the purpose of supplying power to said indicator lamp.

29. The method of claim 23, the printed circuit having mounted thereon electrically conductive rails for electrically connecting the printed circuit to an incandescent bulb socket in the housing for the purpose of supplying power to said indicator lamp, said rails having protrusions which, when inserted into said socket, are in electrical contact with said socket.

30. The method of claim 23, the printed circuit having an opening which fits over said socket.
